(19) United States
(12) Patent Application Publication
(10) Pub. No.: US 2024/0144244 A1
(43) Pub. Date: May 2, 2024

(54) Server and Method

(71) Applicant: TOYOTA JIDOSHA KABUSHIKI KAISHA, Toyota-shi Aich-ken (JP)

(72) Inventors: Tatsuya OWASHI, Nagoya-shi Aichi-ken (JP); Kuniaki MURAKAMI, Nagoya-shi Aichi-ken (JP); Koji HETSUGI, Toyota-shi Aich-ken (JP); Tomokazu ISHII, Okazaki-shi Aichi-ken (JP); Naoki ISHIHARA, Nisshin-shi Aichi-Ken (JP)

(73) Assignee: TOYOTA JIDOSHA KABUSHIKI KAISHA, Toyota-shi Aich-ken (JP)

(21) Appl. No.: 18/494,224

(22) Filed: Oct. 25, 2023

(30) Foreign Application Priority Data
Oct. 28, 2022 (JP) 2022-173433

(51) Int. Cl. G06Q 20/36; G06Q 20/10; G06Q 20/40

(52) U.S. Cl. CPC G06Q 20/3672; G06Q 20/10; G06Q 20/40

(57) ABSTRACT

An entity server includes a communication apparatus and a processor. The communication apparatus is configured to receive a delivery request that requests delivery of a vehicle to a user, the vehicle being associated with an NFT. When the communication apparatus receives the delivery request, the processor performs locking processing for locking the NFT.

### CROSS REFERENCE TO RELATED APPLICATIONS

This nonprovisional application is based on Japanese Patent Application No. 2022-173433 filed with the Japan Patent Office on Oct. 28, 2022, the entire contents of which are hereby incorporated by reference.

### BACKGROUND

### Field

The present disclosure relates to a server and a method.

### Description of the Background Art

Japanese Patent Laying-Open No. 2020-027592 discloses a system that manages on a blockchain, right information on assets. This system includes first and second computer systems. The first computer system manages the right information based on a blockchain technology. The second computer system converts the right information into a token. A holder of the token can possess assets corresponding to the token.

### SUMMARY

A non-fungible token (NFT) has attracted attention as an exemplary token minted based on a distributed ledger technology such as a blockchain technology. It is extremely difficult to counterfeit and tamper the NFT. The NFT, as being associated with a tangible object, can be used as a certificate to certify a right to obtain the tangible object. The NFT may be transferred (bought and sold), for example, in an auction.

When an NFT associated with a tangible object is given to a first user, the first user becomes an NFT holder and acquires the right to obtain the tangible object. Delivery of the tangible object to the first user is thereafter started. During delivery of the tangible object, however, the NFT can illicitly be transferred from the first user to a second user. In this case, the NFT is given to the second user whereas the tangible object is delivered to the first user. Consequently, the second user may be unable to obtain the tangible object in spite of possession of the NFT associated with the tangible object.

The present disclosure was made in view of problems as above, and an object thereof is to prevent unauthorized transfer of an NFT during delivery of a tangible object when the NFT is used for certifying the right to obtain the tangible object.

A server according to the present disclosure includes a communication apparatus and a processor. The communication apparatus is configured to receive a delivery request that requests delivery of a tangible object to a holder of a non-fungible token, the tangible object being associated with the non-fungible token. The processor performs locking processing for locking the non-fungible token when the communication apparatus receives the delivery request.

According to the configuration above, transfer of the non-fungible token is prohibited in response to the delivery request. Such a situation as transfer of the non-fungible token during delivery of the tangible object is thus avoided. Consequently, unauthorized transfer of the non-fungible token can be prevented.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing a configuration of an information processing system according to an embodiment.

FIG. 2 is a diagram showing a configuration of a vehicle.

FIG. 3 is a diagram illustrating a data structure of a distributed ledger recorded in each node of a BLC-NW.

FIG. 4 is a diagram schematically showing a data structure of a transaction history.

FIG. 5 is a diagram exemplifying a screen shown on an HMI apparatus of a user terminal in response to locking processing.

FIGS. 6 and 7 are each a flowchart exemplifying processing performed in connection with minting and sales of an NFT.

FIGS. 8 and 9 are each a flowchart exemplifying processing performed in connection with delivery of a vehicle to a user.

FIG. 10 is a flowchart exemplifying processing performed by an entity server instead of S729 in FIG. 8.

FIG. 11 is a flowchart exemplifying processing performed by the entity server instead of S775 in FIG. 9.

FIG. 12 is a flowchart exemplifying processing performed by the entity server instead of S780 in FIG. 9.

FIG. 13 is a diagram exemplifying a screen shown on a display apparatus of the user terminal.

### DETAILED DESCRIPTION

An embodiment of the present disclosure will be described in detail below with reference to the drawings. The same or corresponding elements in the drawings have the same reference characters allotted and description thereof will not be repeated. The embodiment and a modification thereof may be combined as appropriate. The embodiment below describes a case in which a vehicle is defined as a tangible object by way of example.

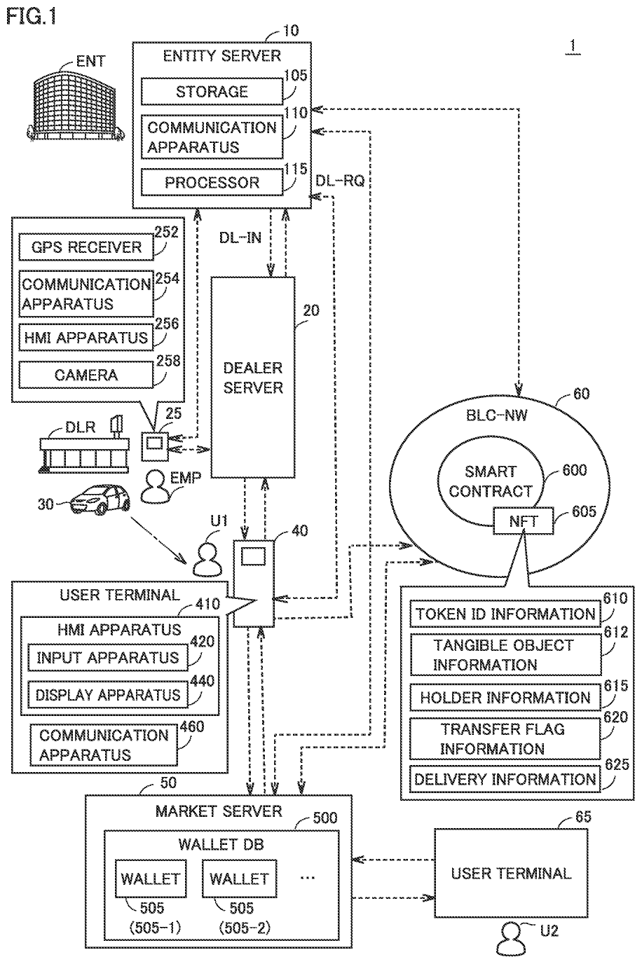

FIG. 1 is a diagram schematically showing a configuration of an information processing system according to an embodiment. Referring to FIG. 1, an information processing system 1 includes an entity server 10, a dealer server 20, a portable terminal 25, a vehicle 30, and user terminals 40 and 65. Information processing system 1 further includes a market server 50 and a blockchain network (BLC-NW) 60 (specifically, a plurality of nodes thereof).

Entity server 10 is operated by an entity ENT. Entity ENT is a manufacturing entity that manufactures vehicle 30 and provides various services with the use of the NFT and vehicle 30. The service includes a sales service for sales of vehicle 30 and a temporary use service such as rental or sharing of vehicle 30. Though vehicle 30 is assumed as a specially built limited luxury car in this example, it may be a vehicle for the general public. Entity server 10 includes a storage 105, a communication apparatus 110, and a processor 115.

A program to be executed by processor 115 and data are stored in storage 105. Communication apparatus 110 communicates with a device outside entity server 10 such as dealer server 20, portable terminal 25, user terminal 40, or each node on BLC-NW 60. Entity server 10 is configured to receive from user terminal 40, a delivery request DL-RQ (which will be described later) that requests delivery of vehicle 30.

Processor 115 includes a central processing unit (CPU) and a memory (neither of which is shown). The memory includes a read-only memory (ROM) and a random access memory (RAM).

Processor 115 has a smart contract 600 registered on BLC-NW 60 through communication apparatus 110. Smart contract 600 is described by entity ENT. Processor 115 transmits transaction data including smart contract 600 for minting an NFT 605 to BLC-NW 60 through communication apparatus 110. Transmission of transaction data to BLC-NW 60 corresponds to broadcasting of transaction data to nodes on BLC-NW 60. After the transaction data is broadcast, the transaction data is propagated to, taken in, and approved by other nodes on BLC-NW 60.

NFT 605 is associated with vehicle 30 and used as a certificate that certifies a right to obtain (purchase) vehicle 30. NFT 605 is sold to a user U1 by entity ENT which is a minter, and possessed by user U1. Entity server 10 transmits a delivery instruction DL-IN that indicates delivery of vehicle 30 to dealer server 20 in response to reception of delivery request DL-RQ.

Dealer server 20 is operated by dealer DLR. Dealer DLR stores and sells vehicle 30. An employee EMP of dealer DLR carries portable terminal 25. Dealer server 20 instructs employee EMP through portable terminal 25 to deliver vehicle 30, in response to delivery instruction DL-IN. Vehicle 30 is thus driven by employee EMP to move to a residential area of user U1 (the NFT holder). Vehicle 30 is thereafter delivered from employee EMP (dealer DLR) to user U1.

Portable terminal 25 includes a global positioning system (GPS) receiver 252, a communication apparatus 254, a human machine interface (HMI) apparatus 256, and a camera 258. GPS receiver 252 detects position information of portable terminal 25. When employee EMP drives vehicle 30 to deliver vehicle 30 to user U1, the position information of portable terminal 25 may be used as position information of vehicle 30. Communication apparatus 254 communicates with a device outside portable terminal 25 such as entity server 10 or dealer server 20. HMI apparatus 256 includes a display apparatus and an input apparatus (neither of which is shown). Camera 258 shoots a shooting target.

User terminal 40 is a terminal apparatus including an HMI apparatus 410 and a communication apparatus 460. HMI apparatus 410 includes an input apparatus 420 and a display apparatus 440. Input apparatus 420 receives input of a user operation by user U1. The user operation includes an operation for generating delivery request DL-RQ that requests delivery of vehicle 30 to user U1. This operation is also expressed as a “delivery request operation.” The user operation includes also an operation for inputting user information that should be registered by user U1 before delivery of vehicle 30. The user information includes information indicating a residential area (an address) of user U1 and information indicating a ground truth image of an identification card of user U1. The identification card includes a driver's license. Display apparatus 440 shows various screens.

Communication apparatus 460 communicates with a device outside user terminal 40 such as entity server 10, dealer server 20, market server 50, and each node on BLC-NW 60. Communication apparatus 460 transmits delivery request DL-RQ to entity server 10 in response to the delivery request operation. Communication apparatus 460 may be configured to receive an electronic key (a digital key) for unlocking a door of vehicle 30 from entity server 10.

Market server 50 functions as a platform that provides an NFT marketplace. This marketplace corresponds to a market used for buying and selling (putting up and successful bidding) of NFT 605. Market server 50 is configured to communicate with each of entity server 10, user terminals 40 and 65, and each node on BLC-NW 60.

Market server 50 includes a wallet database (DB) 500. Wallet DB 500 includes a plurality of wallets 505. Wallet 505 is used for each user so as to store NFT 605 or digital assets such as a virtual currency. In this example, wallets 505-1 and 505-2 are used by user U1 and a user U2 (which will be described later), respectively. Since user U1 is an NFT holder in this example, NFT 605 is stored in wallet 505-1. Specifically, a secret key for accessing NFT 605 is stored in wallet 505-1.

Market server 50 can receive a request for putting up NFT 605 from entity server 10. In this case, market server 50 is granted an NFT transfer authority by entity server 10. The NFT transfer authority corresponds to the authority to transfer NFT 605. Since an NFT seller is entity ENT and a successful bidder is user U1 in this example, the NFT transfer authority includes the authority to transfer NFT 605 from entity ENT to user U1. Market server 50 is granted the NFT transfer authority, and thereafter in response to successful bidding of NFT 605, NFT 605 can be transferred from the seller to the successful bidder. Transfer of NFT 605 refers to transfer of NFT 605 from wallet 505 of the NFT holder to wallet 505 of a trading partner thereof.

User terminal 65 is configured to communicate with market server 50 and used by user U2. User U2 can buy and sell various NFTs through the marketplace provided by market server 50.

BLC-NW 60 is a public blockchain network accessible by each of entity server 10, user terminal 40, and market server 50. Each of entity server 10, user terminal 40, and market server 50 can refer to and check a distributed ledger recorded in a node on BLC-NW 60. Such a distributed ledger includes transaction data on NFT 605. BLC-NW 60 also functions as a platform on which smart contract 600 can be mounted.

Smart contract 600 sets a flag (which will be described later) to 0 when it permits transfer of NFT 605 and sets the flag to 1 when it prohibits transfer of NFT 605.

NFT 605 includes token ID information 610, tangible object information 612, holder information 615, transfer flag information 620, and delivery information 625. In other words, smart contract 600 is described by entity ENT to mint NFT 605 including such information.

Token ID information 610 is used for identification of NFT 605. Tangible object information 612 indicates identification information of the tangible object (in this example, an identification number of vehicle 30) associated with NFT 605. Holder information 615 indicates the holder of NFT 605. In this example, at the time of minting of NFT 605, the NFT holder is entity ENT which is a minter thereof. As a result of sales through the marketplace, however, the NFT holder is subsequently changed from entity ENT to user U1. Holder information 615 is rewritten in response to transfer (buying and selling) of NFT 605. The NFT holder is changed in connection with rewrite of holder information 615.

Transfer flag information 620 indicates whether transfer of NFT 605 is permitted or prohibited. Specifically, transfer flag information 620 includes a flag that can be switched to one of 0 (off) and 1 (on) by smart contract 600. Switching of the flag from 0 to 1 is also expressed as “turn-on of the flag.” Switching of the flag from 1 to 0 is also expressed as “turn-off of the flag.” When the flag is turned on or off, transfer flag information 620 is rewritten to indicate the latest flag.

Only the NFT holder is allowed to set prohibition (on of the flag) of transfer of NFT 605. At the time of minting of NFT 605, the flag has been set to 0 and transfer of NFT 605 is permitted. User U1 transmits, for example, transaction data to turn on the flag to BLC-NW 60 with the use of user terminal 40. When this transaction data is approved by each node on BLC-NW 60, it is registered in the distributed ledger in the node. Thus, even when transaction data for transfer of NFT 605 is transmitted to BLC-NW 60, this transaction data is not approved on BLC-NW 60 and NFT 605 is not transferred. Each of entity server 10, user terminal 40, and market server 50 can determine whether or not the transaction data indicating on of the flag has been registered in the distributed ledger, by referring to the distributed ledger in BLC-NW 60. Each of them can determine whether transfer of NFT 605 is permitted or prohibited based on a result of this determination.

Delivery information 625 indicates whether or not delivery of vehicle 30 from dealer DLR to user U1 has been completed. Specifically, delivery information 625 is set to one of “incomplete” indicating incomplete delivery of vehicle 30 and “complete” indicating completion of delivery of vehicle 30. Delivery information 625 is rewritten from “incomplete” to “complete” in response to completion of delivery of vehicle 30. NFT 605 in which delivery information 625 has been rewritten is also denoted as a “used NFT.” The used NFT no longer functions as the certificate for the right to obtain vehicle 30. How to determine whether delivery is complete/incomplete will be described in detail later.

Holder information 615, transfer flag information 620, and delivery information 625 are based on a state database which will be described later and such information is rewritten in connection with update of the state database.

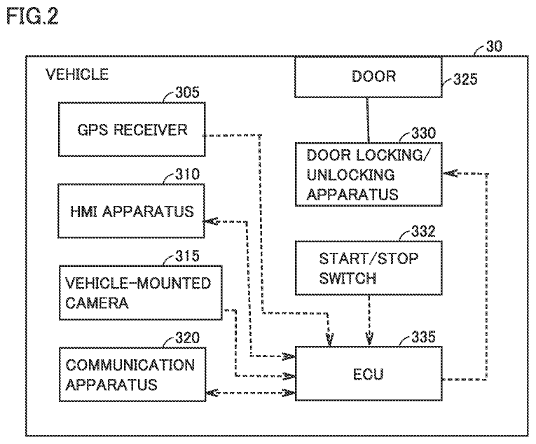

FIG. 2 is a diagram showing a configuration of vehicle 30. Referring to FIG. 2, vehicle 30 includes a GPS receiver 305, an HMI apparatus 310, a vehicle-mounted camera 315, and a communication apparatus 320. Vehicle 30 further includes a door 325, a door locking/unlocking apparatus 330, a start/stop switch 332, and an electronic control unit (ECU) 335.

GPS receiver 305 detects a current position of vehicle 30. HMI apparatus 310 receives input of various user operations such as an operation for input of the user information described previously and shows various screens. Vehicle-mounted camera 315 shoots an image of the inside of a compartment of vehicle 30 or a shooting target around vehicle 30.

Communication apparatus 320 is configured to establish short-range communication with portable terminal 25. This short-range communication allows activation of portable terminal 25 as a smart key that locks/unlocks door 325 or allows portable terminal 25 to function as a remote controller that turns on/off start/stop switch 332. For example, while door 325 is locked, communication apparatus 320 can receive a door unlocking request for unlocking door 325 from portable terminal 25. Door 325 can thus be unlocked. Door locking/unlocking apparatus 330 is mechanically coupled to door 325 and configured to lock or unlock door 325. Activation and deactivation of the remote controller function and the smart key function of portable terminal 25 are set in accordance with an activation instruction and a deactivation instruction transmitted from entity server 10 to portable terminal 25, respectively.

Start/stop switch 332 is operated for switching between start-up and shutdown of a travel system of vehicle 30. Start/stop switch 332 may be turned on/off through short-range communication with the use of portable terminal 25.

ECU 335 obtains information indicating a position detected by GPS receiver 305 (position information of vehicle 30), an image shot by vehicle-mounted camera 315, and a signal indicating on/off of start/stop switch 332. ECU 335 controls various devices of vehicle 30 such as HMI apparatus 310, communication apparatus 320, and door locking/unlocking apparatus 330. When communication apparatus 320 receives the door unlocking request described previously while door 325 is locked, ECU 335 controls door locking/unlocking apparatus 330 to unlock door 325.

In the description below, during a period of storage of vehicle 30 at dealer DLR, the remote controller function and the smart key function of portable terminal 25 are assumed as being inactive until portable terminal 25 receives the activation instruction described previously.

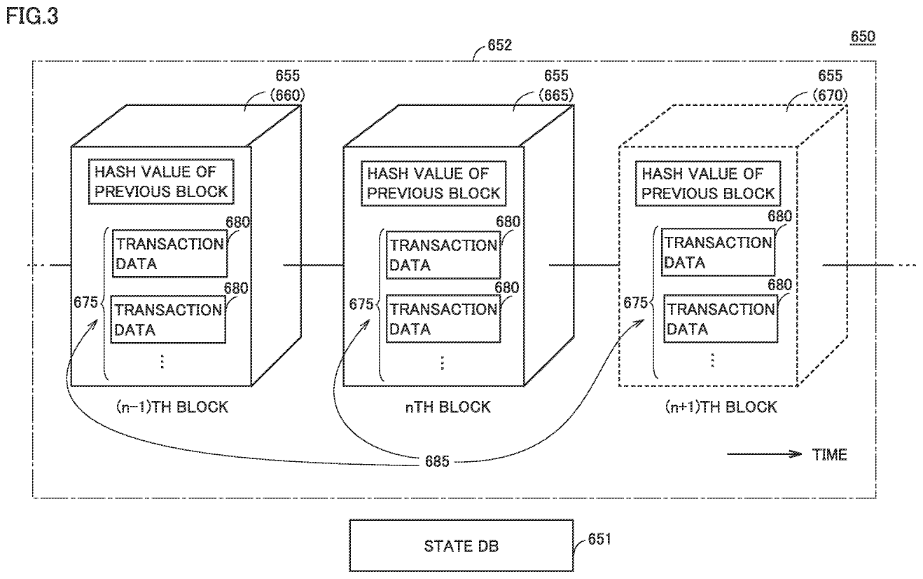

FIG. 3 is a diagram illustrating a data structure of a distributed ledger recorded in each node on BLC-NW 60. Referring to FIG. 3, a distributed ledger 650 includes a state database 651 and a blockchain 652.

State database 651 represents a latest state (for example, the NFT holder, permission/prohibition of transfer of NFT 605, and incomplete/complete delivery at the current time point) of distributed ledger 650.

Blockchain 652 includes a plurality of blocks 655 (blocks 660, 665, and 670 in this example). Each of blocks 655 includes a hash value of a previous block and a data set 675. Data set 675 includes a large number of pieces of transaction data 680. Transaction data 680 may be transaction data on NFT 605. Data composed of a plurality of data sets 675 is also expressed as a transaction history 685.

New block 670 (an (n+1)th block in the figure) includes unapproved transaction data 680. New block 670 is approved (finalized) by mining processing and thereafter added to distributed ledger 650. Transaction data 680 in new block 670 is thus registered in distributed ledger 650 and activated. Such registration of transaction data 680 in distributed ledger 650 corresponds to addition of new block 670 including this transaction data 680 to distributed ledger 650. A consensus algorithm for mining processing includes proof of work (PoW), proof of stake (PoS), or practical Byzantine fault tolerance (PBFT).

When transaction data 680 indicating the new NFT holder is registered, state database 651 is updated to indicate the new NFT holder. When transaction data 680 indicating turn-on of the flag is registered, state database 651 is updated to indicate turn-on of the flag (prohibition of transfer of NFT 605). When transaction data 680 indicating completion of delivery is registered, state database 651 is updated to indicate completion of delivery.

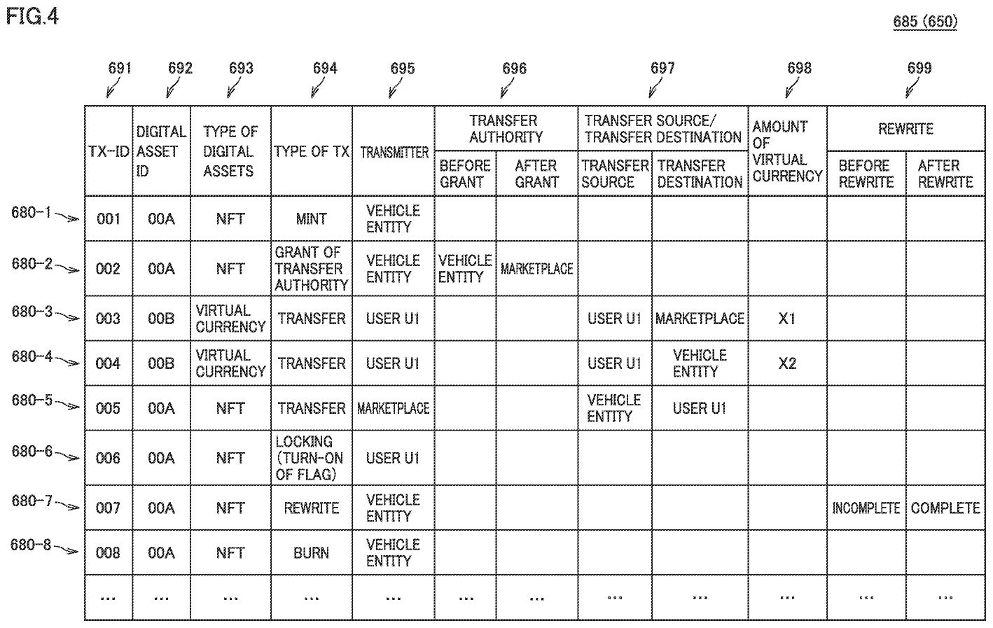

FIG. 4 is a diagram schematically showing a data structure of transaction history 685. Referring to FIG. 4, transaction history 685 includes a plurality of pieces of transaction data 680 (transaction data 680-1 to transaction data 680-8 in this example). Transaction data 680-1 to transaction data 680-8 are registered in this order in distributed ledger 650.

Transaction data 680 includes transaction (TX) ID information 691, digital asset ID information 692, digital asset type information 693, and transaction type information 694. Transaction data 680 further includes transmitter information 695, transfer authority information 696, transfer source/transfer destination information 697, virtual currency amount information 698, and rewrite information 699.

Transaction ID information 691 indicates identification information of a corresponding transaction. Digital asset ID information 692 indicates identification information of digital assets relating to corresponding transaction data 680. Digital asset type information 693 indicates a type of corresponding digital assets. Transaction type information 694 indicates a type of a corresponding transaction. Transmitter information 695 is information indicating a user who has transmitted corresponding transaction data 680 to BLC-NW 60 (specifically, an ID of this user).

Transfer authority information 696 indicates an entity that has the authority to transfer corresponding digital assets over a period around grant of the authority when transaction type information 694 indicates “grant of transfer authority.” Otherwise, transfer authority information 696 is left blank.

Transfer source/transfer destination information 697 indicates a transfer source and a transfer destination of the digital assets when transaction type information 694 indicates “transfer”. Otherwise, transfer source/transfer destination information 697 is left blank.

Virtual currency amount information 698 indicates an amount of virtual currency sent from a remittance source to a remittance destination of the virtual currency when digital asset type information 693 indicates the “virtual currency” and transaction type information 694 indicates “transfer”. Otherwise, virtual currency amount information 698 is left blank.

Rewrite information 699 indicates information to be rewritten over a period around rewrite when transaction type information 694 indicates “rewrite”. In this example, information to be rewritten is information indicating incomplete/complete delivery of vehicle 30. Rewrite information 699 is included in transaction data 680 (680-7) for rewrite of the information to be rewritten from “incomplete” to “complete”. When transaction type information 694 is different from “rewrite”, rewrite information 699 is left blank.

Referring again to FIG. 1, NFT 605, as being associated with vehicle 30, may be used as a certificate to certify the right to obtain vehicle 30. When NFT 605 is stored in wallet 505-1, user U1 becomes the NFT holder and acquires the right to obtain vehicle 30. Thereafter, when user U1 transmits delivery request DL-RQ to entity server 10, delivery of vehicle 30 from dealer DLR to user U1 is started.

NFT 605, however, may illicitly be transferred (sold) from user U1 to user U2 through the marketplace during delivery of vehicle 30 (specifically, during a period from transmission of delivery request DL-RQ until a delivery completion condition which will be described later is satisfied). In this case, NFT 605 is given to user U2, whereas vehicle 30 is delivered to user U1. User U1 thus illicitly obtains both of an amount paid by user U2 and vehicle 30, whereas user U2 may be unable to obtain vehicle 30 in spite of possession of NFT 605. Consequently, since the NFT holder does not necessarily agree with an obtainer of vehicle 30, the obtainer of vehicle 30 may not appropriately be determined based on NFT 605.

Entity server 10 according to the embodiment is configured to address the problem as above. Specifically, when communication apparatus 110 receives delivery request DL-RQ, processor 115 performs locking processing for locking NFT 605. The locking processing corresponds to processing for prohibiting transfer of NFT 605 from wallet 505 of the NFT holder to another wallet 505.

According to the locking processing, NFT 605 is locked in wallet 505-1 in response to delivery request DL-RQ. Transfer of NFT 605 thus becomes impossible and is prohibited. Consequently, such a situation as unauthorized transfer of NFT 605 through the marketplace from user U1 to user U2 during delivery of vehicle 30 can be prevented.

Specifically, the locking processing is request processing for requesting user terminal 40 of user U1 to prohibit transfer of NFT 605 from wallet 505 of the NFT holder to another wallet 505.

As described previously, permission and prohibition of transfer of NFT 605 can be set only by user U1 who is the NFT holder. When user terminal 40 is requested to prohibit transfer of NFT 605 as above, user U1 can be invited to prohibit transfer of NFT 605 (to lock NFT 605 in wallet 505-1). Transfer of NFT 605 is thus prohibited through smart contract 600 in response to the user operation. Consequently, unauthorized transfer of NFT 605 during delivery of vehicle 30 can be avoided.

Specifically, the request processing described previously is processing for requesting user terminal 40 to generate transaction data including smart contract 600 that defines processing for switching the flag set to 0 to the value 1 (processing for turning on the flag). In response to this request, user terminal 40 (user U1) generates transaction data 680 to turn on the flag and transmits the transaction data to BLC-NW 60. Turn-on of the flag is thus approved by BLC-NW 60. Consequently, transfer of NFT 605 is prohibited.

Locking of NFT 605 continues until a delivery completion condition indicating completion of delivery of vehicle 30 is satisfied (until delivery of vehicle 30 to user U1 is completed). Unauthorized transfer of NFT 605 during delivery of vehicle 30 can thus reliably be prevented. Consequently, disagreement between the NFT holder and the obtainer of vehicle 30 during delivery of vehicle 30 to user U1 is avoided. Therefore, the obtainer of vehicle 30 can appropriately be determined based on NFT 605.

The delivery completion condition is, for example, registration of transaction data 680 indicating completion of delivery of vehicle 30 in distributed ledger 650. As described previously, tampering of transaction data 680 is less likely once it is registered in distributed ledger 650. Therefore, when such transaction data 680 indicates completion of delivery of vehicle 30, completion of delivery of vehicle 30 is considered as being highly reliable. When the delivery completion condition is defined as described above, entity server 10 can appropriately make determination as to completion of delivery of vehicle 30.

The delivery completion condition may be reception by communication apparatus 110, of a delivery completion notification indicating completion of delivery of vehicle 30 from portable terminal 25 or user terminal 40. Employee EMP or user U1 may thus notify entity server 10 of completion of delivery of vehicle 30 from employee EMP to user U1.

The delivery completion condition may be defined as a condition that is satisfied when a first condition or a second condition below is satisfied.

The first condition is that a receiver (in this example, user U1) to which vehicle 30 is delivered is reliably authenticated as the NFT holder in accordance with a shot image generated by an imaging apparatus that shoots an image of the driver's license of the receiver. The imaging apparatus is, for example, camera 258 of portable terminal 25 or vehicle-mounted camera 315, and shoots the driver's license presented by the receiver. The shot image is transmitted to entity server 10 by communication apparatus 254 or 320. Whether or not the receiver is the NFT holder is determined by entity server 10 in accordance with a result of comparison between a ground truth image of the driver's license and the shot image, based on a known image authentication technology. The ground truth image is included in the user information described previously, and transmitted to entity server 10 before delivery of vehicle 30. The receiver is authenticated as above. Only when the receiver is confirmed to possess the driver's license, vehicle 30 can be delivered to the receiver. Therefore, such a situation as delivery of vehicle 30 to the NFT holder who does not possess the driver's license can be avoided.

The second condition is entry of a position of vehicle 30 detected by a position detector into a residential area of user U1. GPS receiver 252 or 305 may implement the position detector. The information indicating the residential area is included in the user information described previously. When the delivery completion condition is defined based on the first or second condition as above, entity server 10 can accurately make determination as to completion of delivery of vehicle 30.

When the delivery completion condition is satisfied, in embodiments, entity server 10 (processor 115) performs processing for rewriting delivery information 625 such that delivery information 625 indicates completion of delivery of vehicle 30. Specifically, this processing corresponds to transmission to BLC-NW 60, of transaction data 680 for rewriting the previously-described information to be rewritten from “incomplete” to “complete”. This transaction data 680 is approved by each node on BLC-NW 60 and registered in distributed ledger 650.

In embodiments, NFT 605 may not continue to function as the certificate for the right to obtain vehicle 30 after delivery of vehicle 30. When delivery information 625 is rewritten as above, NFT 605 (the used NFT) no longer functions as the certificate after delivery of vehicle 30 to user U1. Thus, when NFT 605 alone is transferred from user U1 to user U2 after delivery of vehicle 30 to user U1, user U2 (new NFT holder) does not acquire the right to obtain vehicle 30. Consequently, inconvenience caused by disagreement between the new NFT holder and the obtainer (user U1) of vehicle 30 can be avoided.

Entity server 10 (processor 115) may perform delivery permission processing for permitting delivery of vehicle 30 when a locking completion condition indicating completion of locking of NFT 30 is satisfied after the locking processing. Completion of locking of NFT 30 corresponds to switching of the flag from 0 to 1.

When the delivery permission processing is performed as above, delivery of vehicle 30 is permitted after completion of locking of NFT 605. A situation that vehicle 30 is unduly delivered to a person different from user U1 before completion of locking of NFT 605 can thus be avoided. Consequently, vehicle 30 can more reliably be delivered to user U1.

The delivery permission processing is defined to include permission of unlocking of door 325 or permission of start-up of the travel system of vehicle 30. Permission of unlocking of door 325 may be activation of the smart key function of portable terminal 25 (including transmission of the electronic key for unlocking of door 325 to user terminal 40). Permission of start-up of the travel system corresponds to activation of the remote controller function of portable terminal 25 for permission of start-up of the travel system.

When the delivery permission processing is defined as above, unlocking of the door of vehicle 30 or start-up of the travel system of vehicle 30 is permitted after completion of locking of NFT 605. Such a situation that vehicle 30 is unduly driven and unduly delivered to a person different from user U1 before completion of locking of NFT 605 can thus be avoided.

The locking completion condition is, for example, registration of transaction data 680 indicating completion of locking of NFT 605 (switching of the flag from 0 to 1) in distributed ledger 650. When transaction data 680 indicates completion of locking of NFT 605, completion of locking of NFT 605 is highly reliable. Such transaction data 680 is transmitted by user terminal 40 (user U1) to BLC-NW 60.

Entity server 10 can sequentially refer to distributed ledger 650 including finalized block 655. Processor 115 can thus determine whether or not transaction data 680 indicating completion of locking of NFT 605 has been registered, and appropriately determine whether or not the locking completion condition has been satisfied in accordance with a result of the determination.

The locking completion condition may be reception by entity server 10 (communication apparatus 110) from user terminal 40, of a locking completion notification indicating completion of locking of NFT 605. In this case, user U1 transmits to BLC-NW 60, transaction data 680 indicating completion of locking of NFT 605 with the use of user terminal 40, and thereafter transmits the locking completion notification to entity server 10 with the use of user terminal 40.

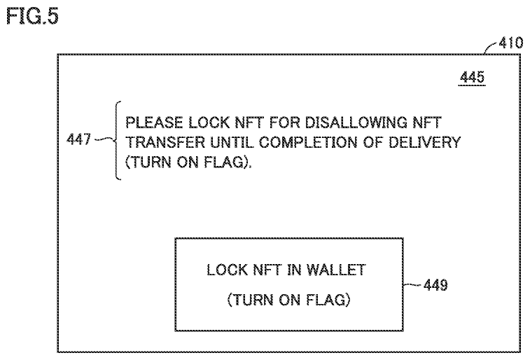

FIG. 5 is a diagram exemplifying a screen shown on HMI apparatus 410 of user terminal 40 in response to the locking processing. Referring to FIG. 5, a screen 445 includes a message 447 and a button 449. While screen 445 is shown, transfer of the NFT is permitted (the flag has been set to 0).

Message 447 invites user U1 to lock NFT 605 (turn on the flag).

Button 449 is operated by user U1 for locking NFT 605 in wallet 505-1. When button 449 is operated, user terminal 40 transmits transaction data 680 indicating locking of NFT 605 to BLC-NW 60. Thereafter, this transaction data 680 is approved and registered in distributed ledger 650.

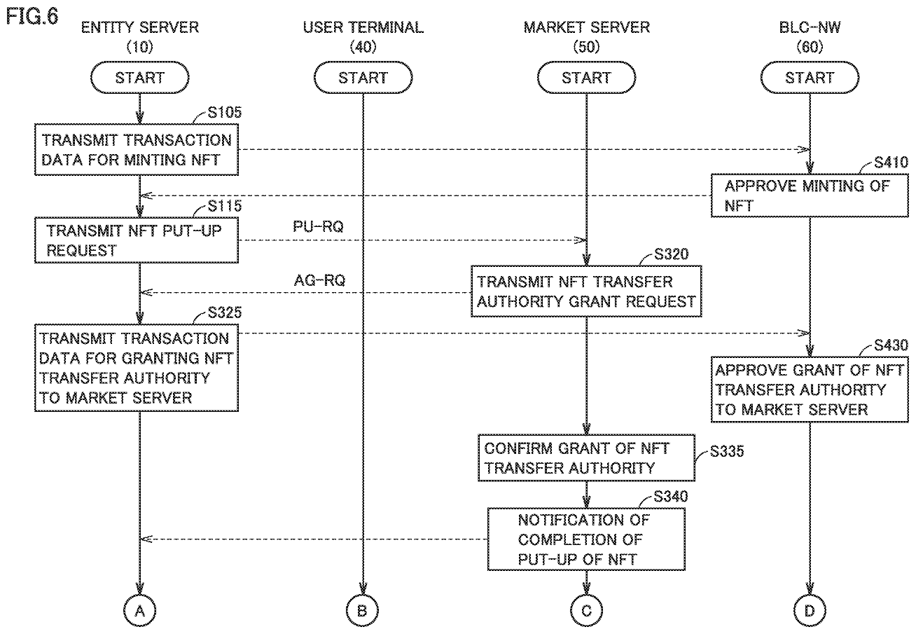

FIGS. 6 and 7 are each a flowchart exemplifying processing performed in connection with minting and sales of NFT 605. A step will be abbreviated as “S” below.

Referring to FIG. 6, entity server 10 transmits transaction data 680 for minting NFT 605 to BLC-NW 60 (S105). Each node on BLC-NW 60 thus approves minting of NFT 605 (S410). Specifically, transaction data 680-1 (FIG. 4) is registered in distributed ledger 650 in each node on BLC-NW 60. Entity ENT is thus approved as the minter (the first NFT holder) of NFT 605.

Entity server 10 transmits an NFT 605 put-up request PU-RQ to market server 50 (S115). Put-up request PU-RQ is generated to request market server 50 to put up NFT 605 on the marketplace.

Market server 50 transmits an NFT transfer authority grant request AG-RQ to entity server 10 in response to reception of put-up request PU-RQ (S320). NFT transfer authority grant request AG-RQ is generated for requesting entity server 10 to grant the NFT transfer authority originally of entity server 10 to market server 50.

Entity server 10 transmits to BLC-NW 60, transaction data 680 for granting the NFT transfer authority to market server 50 in response to reception of NFT transfer authority grant request AG-RQ (S325).

Each node on BLC-NW 60 approves grant of the NFT transfer authority to market server 50 (S430). Specifically, transaction data 680-2 is registered in distributed ledger 650 in each node on BLC-NW 60. Market server 50 thus acquires the NFT transfer authority.

Market server 50 confirms registration on BLC-NW 60, of transaction data 680 indicating grant of the NFT transfer authority, by referring to distributed ledger 650 after S430 (S335). Market server 50 then performs processing for putting up NFT 605 on the marketplace. Thereafter, entity server 10 is notified of completion of put-up of NFT 605 (S340).

Referring to FIG. 7, user terminal 40 requests market server 50 to sell NFT 605 put up on the marketplace to user U1 (a person who desires to purchase the NFT) (S245). Market server 50 requests user terminal 40 to remit the virtual currency such that a price for NFT 605 is paid in virtual currency (S350).

User terminal 40 transmits transaction data 680 indicating an amount of remittance of the virtual currency to BLC-NW 60 (S255). This amount of remittance includes an amount of remittance (a first amount of remittance) to a marketplace operator and an amount of remittance (a second amount of remittance) to entity ENT. The first amount of remittance corresponds to the amount of virtual currency paid as a commission fee to the marketplace operator. The second amount of remittance corresponds to the amount of virtual currency paid by user U1 to entity ENT for purchase of NFT 605.

Each node on BLC-NW 60 approves the first amount of remittance (S460). Specifically, transaction data 680-3 is registered in distributed ledger 650 in each node on BLC-NW 60. The first amount of remittance is put into wallet 505 of the marketplace operator.

Each node on BLC-NW 60 approves the second amount of remittance (S465). Specifically, transaction data 680-4 is registered in distributed ledger 650 in each node on BLC-NW 60. The second amount of remittance is thus put into wallet 505 of entity ENT.

Market server 50 confirms approval of remittance of the virtual currency to each of the marketplace and entity ENT by referring to distributed ledger 650 after S465 (S370). Market server 50 then transmits to BLC-NW 60, transaction data 680 for transfer of NFT 605 from entity ENT which is the NFT minter to user U1 who has purchased the NFT (S375).

Each node on BLC-NW 60 approves transfer of the NFT from entity ENT to user U1 (S480). Specifically, transaction data 680-5 is registered in distributed ledger 650 in each node on BLC-NW 60. State database 651 is thus updated to indicate change of the NFT holder from entity ENT to user U1. NFT 605 is then stored in wallet 505-1.

Market server 50 confirms approval by each node on BLC-NW 60, of transfer of the NFT to user U1 (purchase of NFT 605 by user U1) by referring to distributed ledger 650 after S480. Market server 50 then notifies user terminal 40 of completion of purchase of NFT 605 by user U1 (S485). The process thereafter ends.

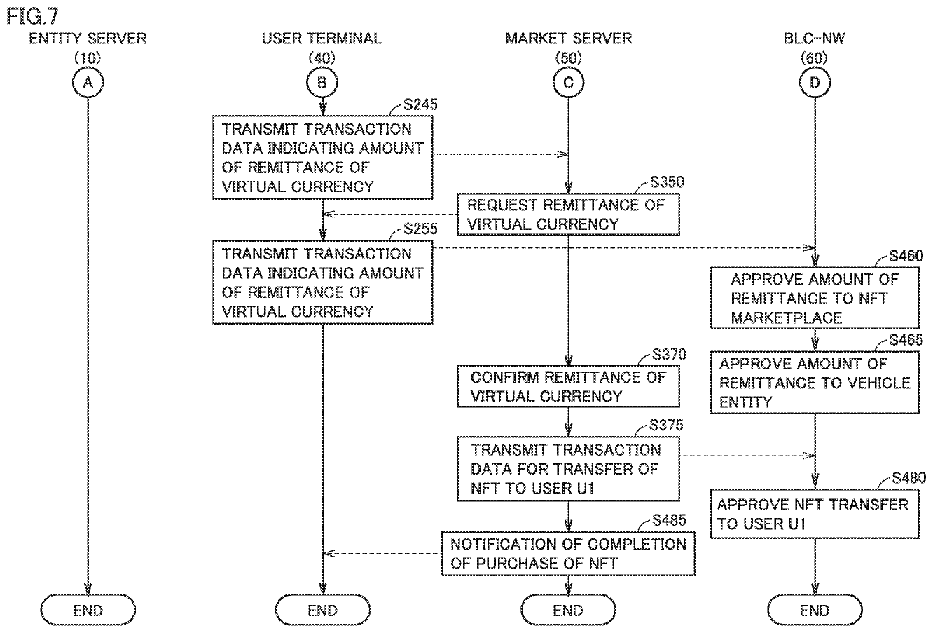

FIGS. 8 and 9 are each a flowchart exemplifying processing performed in connection with delivery of vehicle 30 to user U1. This flowchart is started when user U1 performs the delivery request operation described previously.

Referring to FIG. 8, user terminal 40 transmits delivery request DL-RQ to entity server 10 (S505). Entity server 10 receives delivery request DL-RQ (S710). Entity server 10 requests user terminal 40 to show a screen to receive input of the user information described previously (S715).

When user terminal 40 receives input of the user information from user U1 (S520), it transmits the user information to entity server 10 (S522).

Entity server 10 performs the locking processing (request processing) in response to reception of the user information (S725).

User terminal 40 shows screen 445 (FIG. 5) on HMI apparatus 410 in response to the locking processing. In this example, button 449 is operated by user U1. User terminal 40 then transmits transaction data 680 for locking NFT 605 (for turning on the flag) to each node on BLC-NW 60 in response to this user operation (S535).

Each node on BLC-NW 60 approves locking of NFT 605 (turn-on of the flag) (S840). Specifically, transaction data 680-6 is registered in distributed ledger 650 in each node on BLC-NW 60. NFT 605 is thus locked and transfer thereof is prohibited.

Entity server 10 performs processing for determining whether or not the locking completion condition has been satisfied (S726). In this example, the locking completion condition is registration of transaction data 680 (680-6) indicating completion of locking of NFT 605 in distributed ledger 650.

Entity server 10 switches processing in accordance with whether or not the locking completion condition has been satisfied (S729). Specifically, entity server 10 switches processing in accordance with whether or not transaction data 680-6 has been registered on BLC-NW 60.

When the locking completion condition has not been satisfied (NO in S729), the process returns to S726. When the locking completion condition has been satisfied (YES in S729), entity server 10 performs the delivery permission processing described previously (S750). Entity server 10 then notifies user terminal 40 that vehicle 30 is deliverable (S755).

Referring to FIG. 9, entity server 10 requests dealer server 20 to deliver vehicle 30 to user U1 in accordance with the user information described previously (S765).

Dealer server 20 performs processing for showing a screen for instructing employee EMP to deliver vehicle 30 to user U1 on portable terminal 25 (S670). Vehicle 30 is thus driven by employee EMP to move to the residential area of user U1. Vehicle 30 is then delivered from employee EMP to user U1. Thereafter, employee EMP uses portable terminal 25 to transmit the delivery completion notification indicating completion of delivery of vehicle 30 to entity server 10 (S675).

After S765, entity server 10 determines whether or not the delivery completion condition has been satisfied (S770) and switches processing in accordance with a result of the determination (S775). In this example, the delivery completion condition is reception by entity server 10, of the delivery completion notification from portable terminal 25.

When the delivery completion condition has not been satisfied (NO in S775), the process returns to S770. When the delivery completion condition has been satisfied (YES in S775), entity server 10 performs rewrite processing for rewriting delivery information 625 (S780). Specifically, entity server 10 transmits to BLC-NW 60, transaction data 680 for rewriting the information to be rewritten indicating whether delivery of vehicle 30 is incomplete/complete, from “incomplete” to “complete.”

Each node on BLC-NW 60 approves rewrite from “incomplete” to “complete” (S885). Specifically, transaction data 680-7 is registered in distributed ledger 650 in each node on BLC-NW 60. Any user of a terminal apparatus that can access each node on BLC-NW 60 can thus recognize completion of delivery of vehicle 30 (limited luxury car). Thereafter, the process ends.

Entity server 10 may determine whether or not the locking completion condition has been satisfied in a manner different from S729 in FIG. 8.

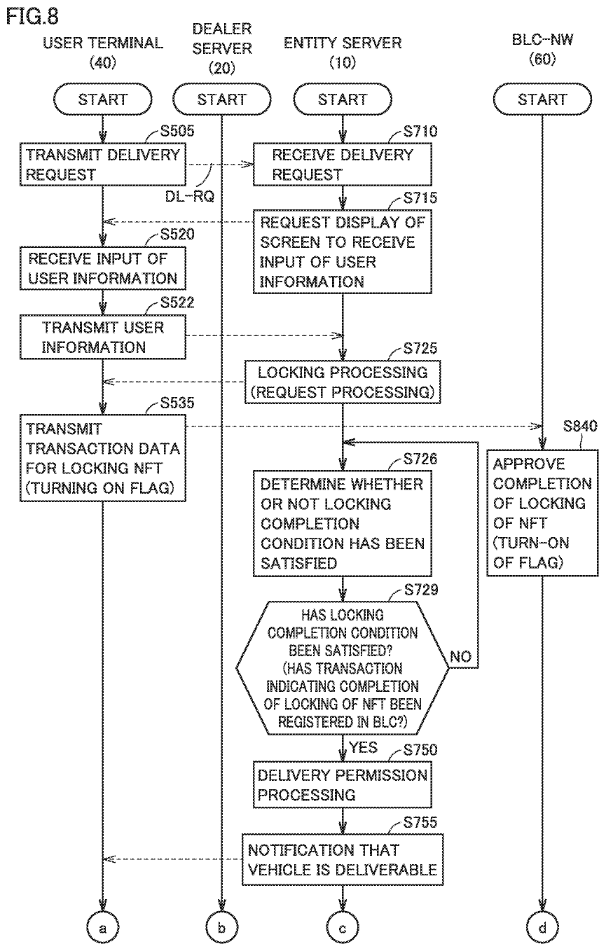

FIG. 10 is a flowchart exemplifying processing performed by entity server 10 instead of S729 in FIG. 8. Referring to FIG. 10, after S725 and 726, entity server 10 determines whether or not the locking completion condition has been satisfied in accordance with whether or not it has received the locking completion notification described previously (S729A). When entity server 10 has not yet received the locking completion notification (NO in S729A), the process returns to S726. When entity server 10 has received the locking completion notification (YES in S729A), on the other hand, the process proceeds to S750.

Entity server 10 may determine whether or not the delivery completion condition has been satisfied in a manner different from S775 in FIG. 9.

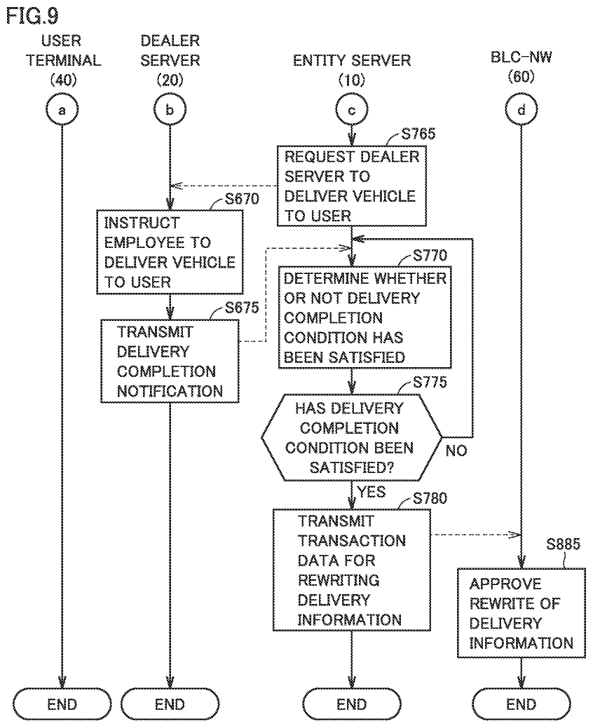

FIG. 11 is a flowchart exemplifying processing performed by entity server 10 instead of S775 in FIG. 9. Referring to FIG. 11, after S765 and 770, entity server 10 determines whether or not the delivery completion condition has been satisfied in accordance with whether or not transaction data 680 (680-7) indicating completion of delivery of vehicle 30 has been registered in distributed ledger 650 (S775A). When transaction data 680-7 has not yet been registered (NO in S775A), the process returns to S770. When transaction data 680-7 has been registered (YES in S775A), on the other hand, the process proceeds to S780.

As set forth above, when entity server 10 receives delivery request DL-RQ, it performs the locking processing (request processing) for locking NFT 605. Such a situation as unauthorized transfer (sales) of NFT 605 through the marketplace from user U1 to user U2 during delivery of vehicle 30 can thus be prevented.

[First Modification]

When the delivery completion condition is satisfied, entity server 10 (processor 115) may perform NFT burning processing for burning NFT 605. Burning of the NFT means transfer of NFT 605 to a burn address of BLC-NW 60. The burn address refers to an address, a secret key of which is known to nobody. The NFT burning processing practically corresponds to deletion of NFT 605.

In embodiments, NFT 605 may not continue to function as the certificate for the right to obtain vehicle 30 after delivery of vehicle 30 to user U1. According to the NFT burning processing, NFT 605 is burnt in response to completion of delivery of vehicle 30. Inconvenience caused by disagreement between the acquirer of the right to obtain vehicle 30 and the obtainer of vehicle 30 can thus be avoided. For example, such an inconvenience that user U2 purchases NFT 605 from user U1 during delivery of vehicle 30 to user U1, and after that, vehicle 30 has already been delivered from dealer DLR to user U1 and user U2 is unable to obtain vehicle 30 can be avoided.

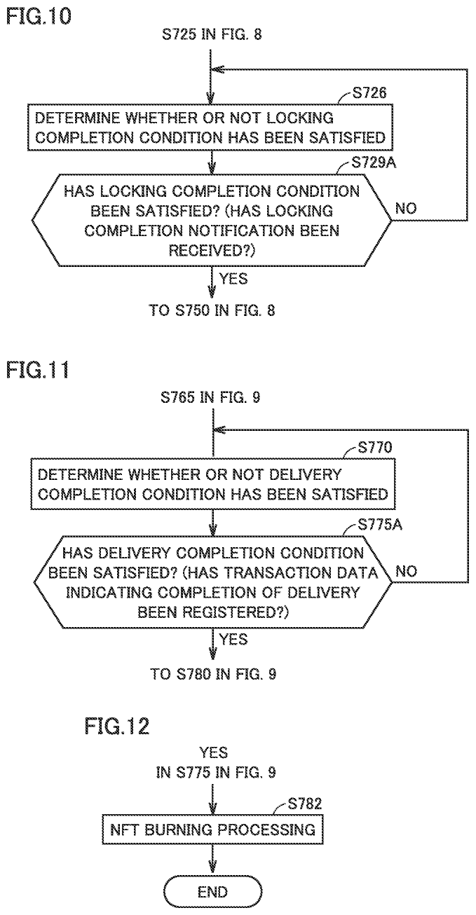

FIG. 12 is a flowchart exemplifying processing performed by entity server 10 instead of S780 in FIG. 9. Referring to FIG. 12, when the delivery completion condition has been satisfied (YES in S775), entity server 10 (processor 115) performs the NFT burning processing (S782). Specifically, entity server 10 transmits to BLC-NW 60, transaction data 680 (680-8) indicating burning of NFT 605. Such transaction data 680 is thus registered in distributed ledger 650 in each node on BLC-NW 60. Consequently, NFT 605 is burnt, and thereafter the process in entity server 10 ends.

[Second Modification]

When NFT 605 (used NFT) in which delivery information 625 has been rewritten is in wallet 505-1 of user U1 (for example, has not yet been sold through the marketplace), entity server 10 (processor 115) may generate image data of vehicle 30 in association with NFT 605. Entity server 10 transmits the generated image data to user terminal 40 and requests user terminal 40 to show an image represented by the image data.

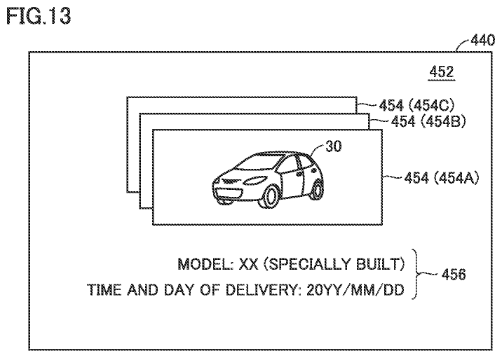

FIG. 13 is a diagram exemplifying a screen shown on display apparatus 440 of user terminal 40. Referring to FIG. 13, a screen 452 functions as an electronic album showing images of vehicle 30 and includes a plurality of images 454 (454A to 454C in this example) and a text 456. Text 456 describes a model and time and day of delivery as information on vehicle 30 corresponding to images 454. In this example, user U1 received delivery of a plurality of vehicles 30 (in other words, purchased the plurality of vehicles 30 in the past) and screen 452 shows images 454 and text 456 for each of vehicles 30.

According to this second modification, user U1 can view images of vehicle 30. Since these images are associated with NFT 605, they are unique. User U1 can thus indulge in reminiscence about past use of vehicle 30 and get complacent. Consequently, the used NFT can effectively be used.

[Third Modification]

When the used NFT is in wallet 505-1 of user U1, entity server 10 (processor 115) may perform preferential sales permission processing. Vehicle 30 is also expressed as a “first vehicle” and a limited luxury car different from vehicle 30 is also expressed as a “second vehicle” below.

Preferential permission processing refers to permission of preferential sales of the second vehicle to user U1 rather than to user U2 in a case in which both of user U1 (the holder of the used NFT) and user U2 (a non-NFT holder) desire purchase of the second vehicle. The case in which these users desire purchase of the second vehicle corresponds to a case in which user terminals 40 and 65 transmit to entity server 10, signals indicating desire of users U1 and U2 to purchase the second vehicle and entity server 10 receives the signals.

User U1 who is the holder of the used NFT has an experience of use, at least once, of a luxury car sales service offered by entity ENT. According to the preferential sales permission processing, even after the first vehicle is delivered to user U1, the used NFT functions as the certificate for the right to preferentially obtain the second vehicle. User U1 who is the holder of the used NFT can thus receive the benefit. Consequently, entity ENT can motivate user U1 to continue to use the luxury car sales service with the use of the NFT.

[Other Modifications]

Though wallet 505 is provided in wallet DB 500 of market server 50, it may be provided in a computer different from market server 50.

BLC-NW 60 is not limited to the public blockchain network. So long as BLC-NW 60 is accessible by each of entity server 10, user terminal 40, and market server 50, another type of distributed ledger network such as a private or consortium blockchain may substitute for BLC-NW 60.

Entity server 10 and dealer server 20 may be integrated with each other. In this case, a server composed of entity server 10 and dealer server 20 forms an exemplary “server” in the present disclosure.

A tangible object associated with the NFT is not limited to vehicle 30. Such a tangible object may be another type of tangible object such as a painting, an antique, a precious stone, precious metal, or a movable body including a sea vessel or an aircraft.

### INDUSTRIAL APPLICABILITY

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A server comprising:
a communication apparatus configured to receive a delivery request that requests delivery of a tangible object to a holder of a non-fungible token, the tangible object being associated with the non-fungible token; and
a processor that performs locking processing for locking the non-fungible token when the communication apparatus receives the delivery request.

2. The server according to claim 1, wherein
the locking processing includes request processing for requesting a terminal apparatus of the holder to prohibit transfer of the non-fungible token from a wallet of the holder to another wallet.

3. The server according to claim 2, wherein
the non-fungible token includes a flag that can be switched to one of a first value and a second value by a smart contract,
the smart contract sets the flag to the first value when it permits the transfer and sets the flag to the second value when it prohibits the transfer, and
the request processing includes processing for requesting the terminal apparatus to generate transaction data including the smart contract that defines processing for switching the flag set to the first value to the second value.

4. The server according to claim 3, wherein
locking of the non-fungible token continues until a delivery completion condition indicating completion of delivery of the tangible object is satisfied.

5. The server according to claim 4, wherein
the processor is configured to refer to transaction data registered in a distributed ledger, and
the delivery completion condition includes registration of the transaction data indicating completion of delivery of the tangible object in the distributed ledger.

6. The server according to claim 4, wherein
the delivery completion condition includes reception, by the communication apparatus, of a delivery completion notification indicating completion of delivery of the tangible object.

7. The server according to claim 4, wherein
the tangible object includes a vehicle,
the delivery completion condition is satisfied when a first condition or a second condition is satisfied,
the first condition is authentication that a receiver to which the tangible object is delivered is the holder, in accordance with an image generated by an imaging apparatus that shoots an image of an identification card of the receiver, and
the second condition is entry of a position of the vehicle detected by a position detector into a residential area of the holder.

8. The server according to claim 4, wherein
when a locking completion condition indicating switching of the flag from the first value to the second value is satisfied after the locking processing, the processor performs permission processing for permitting the delivery.

9. The server according to claim 8, wherein
the processor is configured to refer to transaction data registered in a distributed ledger, and
the locking completion condition includes registration of the transaction data indicating switching of the flag from the first value to the second value in the distributed ledger.

10. The server according to claim 8, wherein
the locking completion condition includes reception, by the communication apparatus, of a locking completion notification indicating switching of the flag from the first value to the second value.

11. The server according to claim 8, wherein
the tangible object includes a vehicle, and
the permission processing includes permission of unlocking of a door of the vehicle or permission of start-up of a travel system of the vehicle.

12. The server according to claim 4, wherein
the non-fungible token includes delivery information indicating whether delivery of the tangible object has been completed, and
when the delivery completion condition is satisfied, the processor performs processing for rewriting the delivery information such that the delivery information indicates completion of delivery of the tangible object.

13. The server according to claim 12, wherein
when the non-fungible token in which the delivery information has been rewritten is in the wallet, the processor generates image data of the tangible object in association with the non-fungible token.

14. The server according to claim 4, wherein
when the delivery completion condition is satisfied, the processor performs processing for burning the non-fungible token.

15. A method comprising:
receiving a delivery request that requests delivery of a tangible object to a holder of a non-fungible token, the tangible object being associated with the non-fungible token; and
performing locking processing for locking transfer of the non-fungible token in response to reception of the delivery request.
